(19) United States
(12) Patent Application Publication
(10) Pub. No.: US 2012/0024683 A1
(43) Pub. Date: Feb. 2, 2012

(54) TACTILE INTERFACE FOR A COMPACT ELECTRONIC DEVICE

(76) Inventor: LeRoy A. Prohofsky, Eden Prairie, MN (US)

(21) Appl. No.: 13/071,644

(22) Filed: Mar. 25, 2011

Related U.S. Application Data
(60) Provisional application No. 61/368,097, filed on Jul. 27, 2010.

(51) Int. Cl. H01H 13/76

(52) U.S. Cl. 200/5 A

(57) ABSTRACT

In a compact electronic device having switches controlling a plurality of commands, the user interface is conditionally modified to enable the user to invoke a subset of the total command set under conditions of diminished tactile or visual acuity.

### CROSS-REFERENCED TO RELATED APPLICATIONS

This application is a non-provisional application of Application No. 61/368,097, filed Jul. 27, 2010 and claims priority from that application which is also deemed incorporated by reference in its entirety in this application.

### STATEMENT REGARDING FEDERALLY SPONSORED RESEARCH OR DEVELOPMENT

Not applicable.

### BACKGROUND OF THE INVENTION

I. Field of the Invention

MP3 players, such as the iPod Nano 5G manufactured by Apple Corporation, are examples of compact electronic devices that are the subject of this invention. The switch control surfaces of this device are constrained to a one-inch circular array. A primary function switch toggles between the “play” and “pause” modes while four auxiliary switches function to navigate the control menu of the device. Since the switch array is vulnerable to unintended actuation a well-protected switch located on the top edge of the iPod is used to lock the switch array. While locked, a user may still perform the primary “play/pause” function using an in-line switch incorporated into the earphones to signal this command to the iPod. The iPod is configured to sense the in-line switch contacts via a third ring on the earphone jack. The in-line switch solution is very indicative of the problem solved by the instant invention. Without the combination of the “lock” and “in-line” switch any interaction with the Ipod requires a relatively high degree of visual or tactile acuity and a well-controlled environment. There are several types of protective enclosures available for the Ipod Nano 5G MP3 player.

The polycarbonate enclosures, which are comprised of two snap-together pieces, are the most relevant. The “iSee” enclosure manufactured by Contour Design of Windham N.H. is typical of this type. The thickness of the polycarbonate case is sufficient to form a protective perimeter making an unlocked iPod relatively immune to unintended actuation while stored in a pocket, but this configuration does not provides sufficient tactile feedback to enable the user to operate the device in situ, particularly with a gloved hand. The user must receive tactile feedback communicated through intervening fabric to control a compact electronic device while it is being worn under clothing. I have chosen to refer to this capability as “remote tactile communication” and for purposes of this specification define it as the ability to communicate with a selected control surface beneath fabric equivalent to a single layer of 20-ounce cotton denim. The ability to exert control through an intervening medium such as a glove or clothing is of particular advantage. Skiing, construction work, gardening or food service are examples of situations where controlling a device while it is worn in a protected place avoids the inconvenient or detrimental consequences of direct contact. A device with such capability would also reduce the visual or tactile acuity required for direct contact operation and would aid in compensating for sensory impairment.

II. Related Art

### Summary of the Invention

The object of the invention is to provide an improved user interface for a compact electronic device wherein at least one function can be invoked using remote tactile communication.

It is a further object of the invention to accomplish these improvements without materially increasing the footprint of the switch array.

It is a further object of the invention to incorporate elements of the invention into a structure, which may be detached from the compact electronic device.

These and other objects are achieved by providing a tactile user interface for actuating the switches of a switch array of an electronic device to control the tasks performed by an electronic device, the tactile user interface comprising a tactile switch locator proximate to the array which includes a vertically displaced surface portion sensed by touch to orient the user relative to the location of the array, and an asymmetric surface allowing the user to determine the position of the individual switches of the array by touch so that the user can actuate such switches to control the electronic device. The tactile user interface may also include at least one surface portion that inhibits accidental actuation of the switches of the array.

### BRIEF DESCRIPTION OF THE DRAWINGS

FIG. 1 is an isometric top view showing a prior art compact electronic device employing the type of compact switch array that is the subject of this invention.

FIG. 2 is an exploded isometric top view of the compact electronic device of FIG. 1 wherein remote tactile communication is enabled by modifying the physical user interface.

FIG. 3 is an isometric top view of the device of FIG. 2 showing the elements of the invention integrated into a common structure.

FIG. 4 is an isometric top view of a detachable protective enclosure for the device of FIG. 1 having moveable surfaces which effect actuation of respective elements of switch array 12 of FIG. 1.

FIGS. 5a, 5b and 5c provide additional detail regarding the structure and function of the enclosure of FIG. 4.

FIGS. 5d and 5e are alternative inserts for the enclosure of FIG. 4.

FIG. 6 is an exploded isometric top view of the compact electronic device of FIG. 1 wherein remote tactile communication is enabled by modifying the functional user interface.

### DETAILED DESCRIPTION

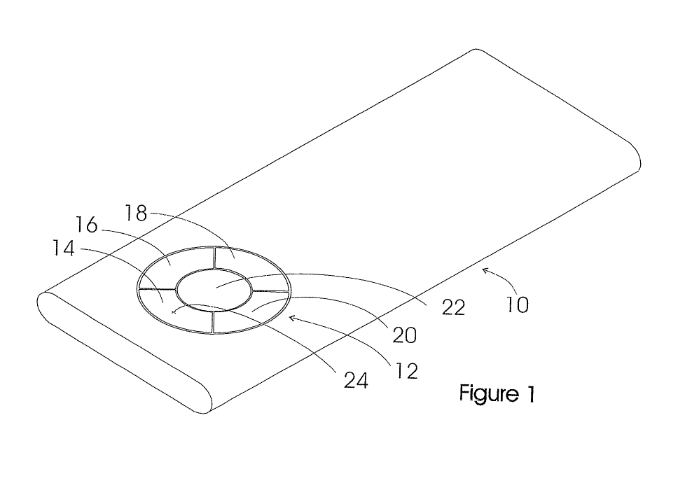

Device 10 of FIG. 1 generally conforms to the prior art iPod Nano 5G MP3 player, an Apple Corporation product. Switch array 12 is a one-inch planar array comprised of switch control surfaces 14,16, 18, 20 and 22, of which surface 14 controls a primary function. When in the “play” mode, switch 14 toggles between the “play state and the “paused” state while switch 16 moves up the play list and switch 20 moves down the play list. Switches 18 and 22 are used to navigate and program the data library of the device. In addition to performing their individual functions, switch surfaces 14, 16, 18 and 20 collectively function as a click wheel to sense the angular displacement of finger contact (See U.S. Pat. No. 7,667,148 entitled “METHOD, DEVICE, AND GRAPHICAL USER INTERFACE FOR DIALING WITH A CLICK WHEEL”). Due to the popularity of the click wheel function it is preferable that any modification to switch array 10 retain this capability by keeping these surfaces accessible. Each switch control surface has a center point of contact that is the centroid of the user's nominal touch pattern. The center point of contact for surface 14 is indicated by symbol 24.

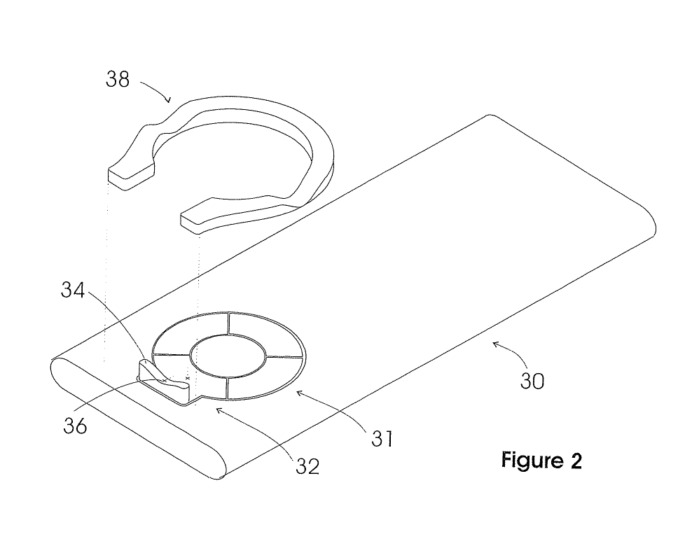

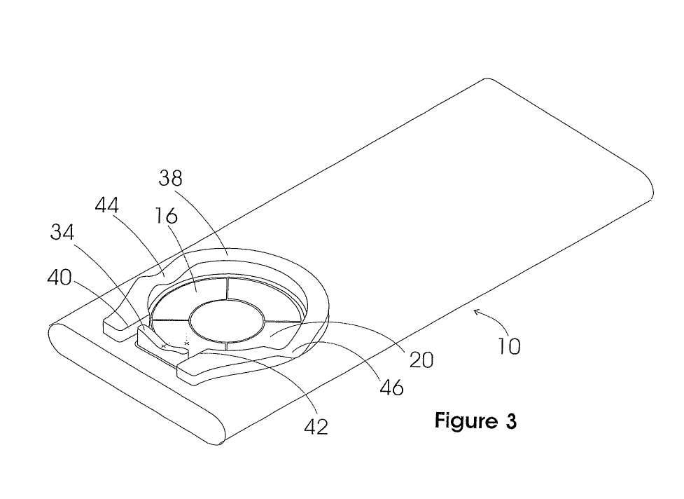

Device 30 of FIG. 2 is the device 10 of FIG. 1 modified according to the invention. Switch array 31 includes a primary function switch 32 corresponding to switch 12 of FIG. 1. Primary function switch 32 includes an elevated surface 34 to create a center point of contact 36 displaced from the original point of contact 28. The vertical component of this displacement makes switch 32 more accessible to the user while the horizontal component of displacement leaves the remaining surface of switch 32 also accessible to the user as a component of the aforementioned click wheel. Structure 38 has been exploded to clearly show the features of switch 32. Its function will be discussed with respect to FIG. 3.

FIG. 3 is the un-exploded view of the device of FIG. 2 showing structure 38 integrated with the body of device 10. Structure 38 may take a variety of forms. The only requirements are that it protect all switches from inadvertent actuation and inform the user about their location through the sense of touch. The utility of tactile information is enhanced by bold asymmetric features, which guide the user to the desired switch. After an initial touch anywhere on structure 38 the user easily finds surface 34, aided by distinct edges 40 and 42, even with substantially diminished tactile acuity. Weaker tactile clues are provided by depressions 44 and 46 to locate switch surfaces 16 and 20 respectively. In this embodiment the surfaces associated with edges 40 and 42 function as a switch locator for certain switches. Structure 38 is thus akin the eyes and mouth of the iconic yellow “smiley face disk. Whatever the orientation of the disk, its features are so distinct and recognizable that the mind is immediately able to reckon the locations of the ears chin and nose. Structure 38 functions in the same way in the tactile domain to enable the user to reckon switch locations. The embodiment of FIG. 3 shows a displaced center point of contact for a particular switch. The concept is extendable to any peripheral switch of a compact switch array or a plurality of such switches.

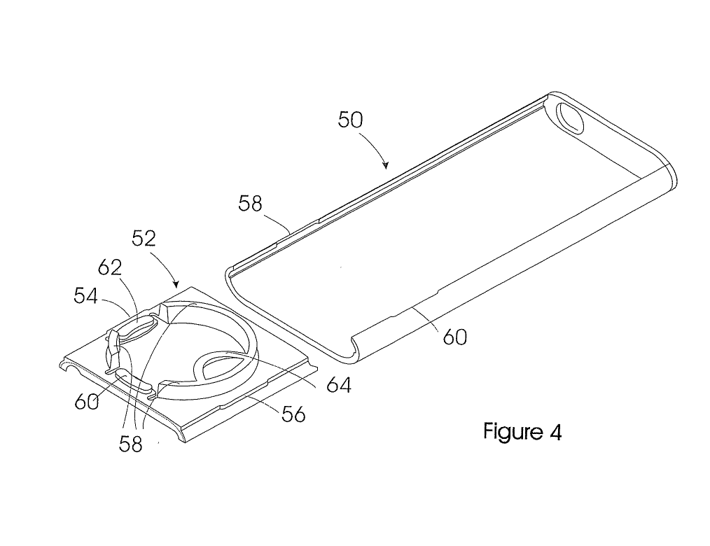

FIG. 4 shows a two-piece interlocking enclosure for device 10 of FIG. 1 wherein the elements of the invention are incorporated in a detachable insert. Device 10 (not shown) is positioned within shell 50, after which insert 52 is added to complete the enclosure. Tabs 54 and 56 engage recesses 58 and 60, respectively, to lock insert 52 in a position accurately registered to switch array 12 (not shown). Surface 58 is comprised of three fixed segments of arc that collectively correspond to yoke 38 of FIG. 2. Switch surfaces 60 and 62 are part of moveable structures which function to actuate switches 14 and 16 of FIG. 1. Surface 64 is also moveable to actuate switch surface 20 of FIG. 1. Switch surface 64 is located within, and nominally co-planar to, the perimeter of surface 58 thus making it both highly accessible and yet relatively immune to inadvertent actuation. In this embodiment switch surface 64 functions as a switch locator for certain switches. Insert 52 thus provides three distinct levels of accessibility. Switch surface 64 can be selectively actuated using a diffuse force without any tactile feedback. Dumping it with the heel of the hand would suffice. Either of Switch surfaces 62 or 64 can be actuated with limited tactile or visual acuity while all other switch array functions can be actuated with normal acuity. As described with respect with FIG. 3, this tiered level of accessibility is achieved by selectively displacing the center point of actuation of certain switches. Insert 52 may be modified to clip on to device 10 without relying on shell 50 to lock it in position if an adhesive is used. A repositionable adhesive such as the “Easy Tack 7020” distributed by the Krylon Products Group of Cleveland Ohio allows for repeated removal and reattachment.

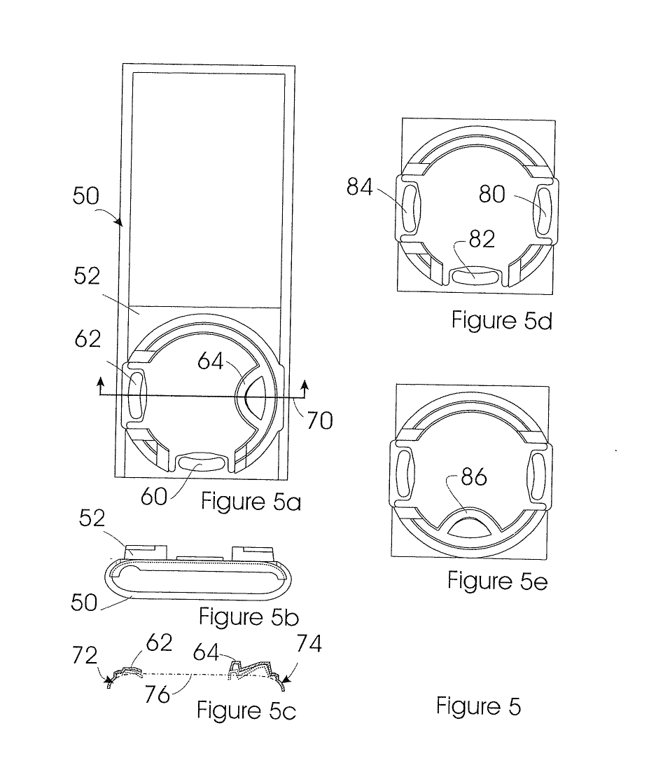

FIG. 5 shows additional details regarding the enclosure of FIG. 4. FIGS. 5a and 5b are top and end views of shell 50 and insert 52 shown in the locked configuration. Line 70 indicates the location of the cross-sectional view shown in FIG. 5c. Line 76 indicates the position of the top surface of the enclosed device 10. The solid lines of structure 72 show its position when unactuated while the dashed lines show the movement which effects actuation. Preferably, the geometry of structure 72 should be chosen for high compliance and a short stroke to be responsive to a light finger touch. Structure 74 is akin to structure 72, however here the compliance should be relatively lower and the stroke longer such that a more deliberate and vigorous action is required thus compensating for its relative susceptibility to unintended actuation. Interchangeable inserts allow users to elect their preferences regarding the degree of accessibility assigned to each switch function. For example, the alternative insert of FIG. 5d allows the user unrestricted use of the aforementioned click wheel function by choosing a peripheral type of structure for switch surfaces 80,82, and 84, while the alternative insert of FIG. 5e assigns the highly accessible switch surface 86 to the pause function.

The previously disclosed embodiments illustrate how modification of the physical user interface enables remote tactile communication. Further advantage is gained by modifying the functional interface.

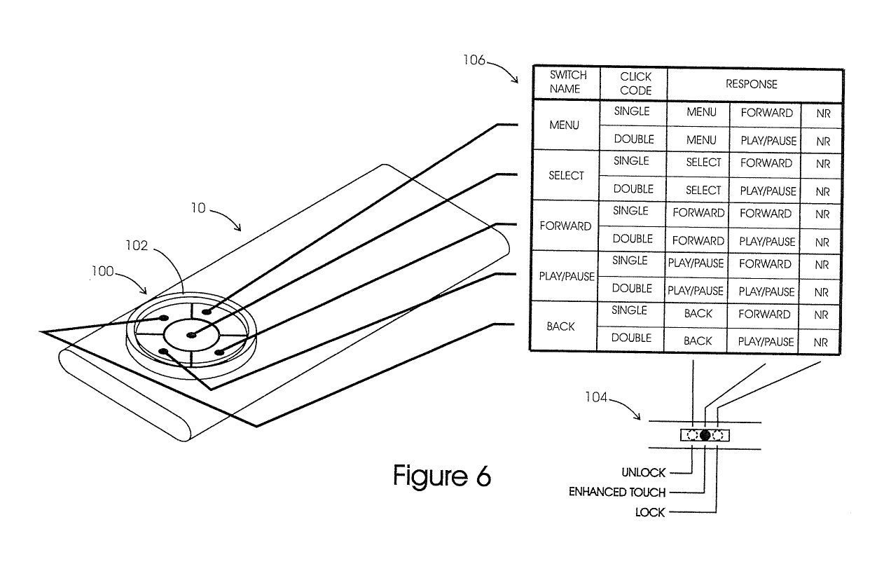

FIG. 6 shows switch array 100, which is comprised of switch array 12 of FIG. 1 plus guard ring 102. Tactile sensing is enhanced by the elevation of guard ring 102. Prior art devices typically include a two-position switch in which the unlocked position allows normal operation of the device while the locked position inhibits all operations. Mode selection switch 104 includes the UNLOCK and LOCK positions of the prior art plus a middle position by which the user can select the ENHANCED TOUCH mode of operation. While in this mode the user is able to convey command information to device 10 via the aggregation of all switch elements of switch array 100 using a pulse signaling protocol. Less tactile acuity is required because switch array 102 gains the desirable attributes of a typical computer mouse selection button, i.e., a relatively large target area for signaling selections constrained by the signal code set. Alternatively, the selection of the ENHANCED TOUCH mode may be implemented as an additional menu option available while in the UNLOCK mode using the LOCK state to force reversion to normal operation.

The signaling protocol may be any of a variety of well-known forms and the user may be allowed some degree of choice in selecting preferences. Selection may be done while in the UNLOCK mode and may include selection of a code set specific to a task of a multitask device. In this example the user has selected a code set for playing MP3 files and has elected to assign the single click signal to the FORWARD command and the double click signal to the PLAY/PAUSE command. These conditions are reflected in look-up table 106. The Column titled “SWITCH NAME” indicates the signal source while the column title “CLICK CODE” indicates the signaled code. The remaining columns indicate the variable response invoked by each signaling event as a function of the state of mode selection switch 104. In the “UNLOCK” position each response corresponds to the named function of the corresponding switch and in the “LOCK” position all response is inhibited (NR=no response). In the “ENHANCED TOUCH” position each response corresponds to the signaled code independent of the signal path. It is intended that the switch array always behave as if it were a single switch surface while in the ENHANCED TOUCH mode. A double click should be detected even when click signals originate from different switches or from a combination of switches. This is accomplished by performing pulse code analysis on the logical OR of all switch signals. While it is most efficient to employ an available physical switch array for signaling in the ENHANCED TOUCH mode, a physical switch dedicated to pulse code signaling can provide the advantages of the embodiment of FIG. 6 when the available control surfaces are virtual or spatially incoherent. For example, a touch-screen device might implement such a switch on any available external surface where it can be easily located. A multifunction device could provide a menu of signal protocols, each protocol optimized for a specific task. The range of control for switch array 100 could also be extended to remote devices by incorporating a wireless capability in device 10.

This invention has been described herein in considerable detail in order to comply with patent statutes and to provide those skilled in the art with the information needed to construct a user interface according to the novel principles disclosed. However, it is to be understood that the invention can be carried out by specifically different means, and that various modifications, both as to the equipment and operating means, can be accomplished without departing from the spirit and scope of the invention.

What is claimed is:

1. A tactile user interface for actuating the switches of a switch array of an electronic device to control the tasks performed by an electronic device, the tactile user interface comprising a tactile switch locator proximate to the array which includes a vertically displaced surface portion sensed by touch to orient the user relative to the location of the array, and an asymmetric surface allowing the user to determine the position of the individual switches of the array by touch so that the user can actuate such switches to control the electronic device.

2. The tactile user interface of claim 1 further including at least one surface portion that inhibits accidental actuation of the switches of the array.
